(19) United States
(12) Patent Application Publication
(10) Pub. No.: US 2017/0121214 A1
(43) Pub. Date: May 4, 2017

(54) FLOAT GLASS FOR CHEMICAL STRENGTHENING

(71) Applicant: ASAHI GLASS COMPANY, LIMITED, Chiyoda-ku (JP)

(72) Inventors: Kazuhiko YAMANAKA, Tokyo (JP); Akio KOIKE, Tokyo (JP); Yusuke FUJIWARA, Tokyo (JP); Daisuke KOBAYASHI, Tokyo (JP); Yosuke AMINO, Tokyo (JP); Ryoji AKIYAMA, Tokyo (JP); Masanobu SHIRAI, Tokyo (JP)

(73) Assignee: ASAHI GLASS COMPANY, LIMITED, Chiyoda-ku (JP)

(21) Appl. No.: 15/350,658

(22) Filed: Nov. 14, 2016

Related U.S. Application Data
(63) Continuation of application No. 14/140,728, filed on Dec. 26, 2013.
Application No. 14/140,728 is a continuation of application No. PCT/JP2012/066064, filed on Jun. 22, 2012.

(30) Foreign Application Priority Data
Jul. 1, 2011 (JP) 2011-147494
Dec. 8, 2011 (JP) 2011-268931

(51) Int. Cl. C03C 3/087; C03C 4/18; C03C 3/085; C03C 21/00; C03B 18/02

(52) U.S. Cl. CPC C03C 3/087; C03C 21/006; C03B 18/02; C03C 3/085; C03C 4/18; C03C 2204/00

(57) ABSTRACT

A float glass for chemical strengthening, having a bottom surface to contact a molten metal during molding and a top surface facing the bottom surface. An absolute value of a difference between a normalized hydrogen concentration at a depth of 5 to 10 μm that is a value obtained by dividing a hydrogen concentration at a depth of 5 to 10 μm by a hydrogen concentration at a depth of 50 to 55 μm in the top surface and the normalized hydrogen concentration at a depth of 5 to 10 μm in the bottom surface is 0.35 or less.

### TECHNICAL FIELD

The present invention relates to a float glass for chemical strengthening.

### BACKGROUND ART

In recent years, in a flat panel display device such as a mobile phone or a personal digital assistant (PDA), in order to enhance protection and beauty of a display, a thin sheet-shaped cover glass is arranged on a front surface of a display so as to cover a region wider than an image display area.

Weight reduction and thickness reduction are required for such a flat panel display device, and to achieve the requirement, a cover glass used for protecting a display is also required to reduce its thickness.

However, when the thickness of a cover glass is reduced, strength thereof is decreased, and the cover glass itself may break during use or by drop during carrying. Therefore, there is a problem that the primary role of protecting a display device cannot be performed.

For this reason, to improve scratch resistance, in the conventional cover glass, a float glass produced by a float process is chemically strengthened to form a compressive stress layer on the surface thereof, thereby enhancing scratch resistance of the cover glass.

In recent years, the higher scratch resistance is required for a cover glass and the like. The surface compressive stress of a chemically strengthened float glass obtained by chemically strengthening the conventional soda lime glass was about 500 MPa, and a depth of a compressive stress layer was approximately about 10 μm. To respond to the requirement of high scratch resistance, a chemically strengthened float glass having a surface compressive stress of 600 MPa or more and a depth of a compressive stress layer of 15 μm or more is developed.

It is reported that warpage occurs in a float glass after chemical strengthening, thereby deteriorating flatness (Patent Document 1). The warpage occurs by the difference of the degree of behavior of chemical strengthening between a glass surface that does not contact with molten tin during float molding (hereinafter referred to as a “top surface”) and a glass surface that contacts with molten tin during float molding (hereinafter referred to as a “bottom surface”).

The warpage of a float glass becomes large with increasing the degree of behavior of chemical strengthening. Therefore, in a chemically strengthened float glass having the surface compressive stress of 600 MPa or more and a depth of a compressive stress layer of 15 μm or more, which has been developed to respond to the requirement of high scratch resistance, the problem of warpage becomes more obvious as compared with the conventional chemically strengthened float glass having the surface compressive stress of about 500 MPa and a depth of a compressive stress layer of about 10 μm.

Conventionally, it has been considered that the reason that the degree of behavior of chemical strengthening differs between the top surface and the bottom surface in a float glass is due to that a molten metal invades the glass surface contacting the molten metal during float molding (Patent Document 1).

Patent Document 1 discloses that a sheet-shaped body produced by a float process and processed is chemically strengthened after dipping in or contacting Li ion, Na ion or a mixed inorganic salt thereof without surface polishing, thereby improving the warpage.

Furthermore, conventionally, to reduce the warpage, a coping method of decreasing strengthening stress by chemical strengthening or removing a surface heterogeneous layer by subjecting a top surface and bottom surface of a float glass to grinding treatment or polishing treatment, and then chemically strengthening the float glass, has been carried out.

### PRIOR ART DOCUMENTS

### Patent Document

Patent Document 1: Japanese Patent No. 2033034

### SUMMARY OF THE INVENTION

### Problems that the Invention is to Solve

However, the method described in Patent Document 1 is required to dip a float glass in a mixed inorganic salt before chemical strengthening, and therefore is complicated. Furthermore, there is a possibility in a method of decreasing strengthening stress that strength of a float glass after chemical strengthening becomes insufficient.

Furthermore, a method of subjecting a top surface and bottom surface of a float glass to grinding treatment or polishing treatment before chemical strengthening has the problem from the standpoint of improvement in productivity, and it is preferred to omit the grinding treatment or polishing treatment.

Therefore, the present invention has an object to provide a float glass for chemical strengthening that can effectively suppress warpage after chemical strengthening and additionally can omit or simplify a polishing treatment or the like before chemical strengthening.

### Means for Solving the Problems

The present inventors have found that a main reason that the difference occurs in the degree of behavior of chemical strengthening between a bottom surface and a top surface of a float glass is not caused by the molten metal invaded in a glass surface contacting the molten metal during float molding, but is caused by the difference in hydrogen concentration between the top surface and the bottom surface. They have further found that when the difference in hydrogen concentration is decreased, the degree of behavior of strengthening by chemical strengthening in the top surface and that in the bottom surface can be balanced and the warpage of a float glass after chemical strengthening can be reduced. They have further found that the hydrogen concentration in the bottom surface of the float glass and in the top surface of the float glass can be evaluated with narrower error range by measuring β-OH in a surface layer. They have completed the present invention based on those findings.

Specifically, the present invention is as follows.

1. A float glass for chemical strengthening, having a bottom surface to contact a molten metal during molding and a top surface facing the bottom surface, wherein an absolute value of a difference between a normalized hydrogen concentration at a depth of 5 to 10 μm that is a value obtained by dividing a hydrogen concentration at a depth of 5 to 10 μm by a hydrogen concentration at a depth of 50 to 55 μm in the top surface and the normalized hydrogen concentration at a depth of 5 to 10 μm in the bottom surface is 0.35 or less;

the hydrogen concentration at a depth of 5 to 10 μm and the hydrogen concentration at a depth of 50 to 55 μm being values (average values) measured under the following analysis conditions, respectively:

### (Analysis Conditions)

Measuring apparatus: Secondary ion mass spectrometer having quadrupole mass analyzer;

Primary ion species: Cs⁺;

Primary accelerated voltage: 5.0 kV;

Primary ion current: 1 μA;

Primary ion incidence angle (angle from vertical direction of sample surface): 60°;

Luster size: 200×200 μm²;

Detection region: 40×40 μm²;

Secondary ion polarity: Minus; and

Use of electron gun for neutralization: Yes.

2. A float glass for chemical strengthening, having a bottom surface to contact a molten metal during molding and a top surface facing the bottom surface, wherein regarding a normalized intensity at a depth of 5 to 10 μm that is a value obtained by, in [¹H⁻/³⁰Si⁻] profile up to a depth of 60 μm measured under the following analysis conditions using a secondary ion mass spectrometer, dividing [¹H⁻/³⁰Si⁻] at a depth of 5 to 10 μm by [¹H⁻/³⁰Si⁻] at a depth of 50 to 55 μm, an absolute value of a difference between the normalized intensity in the top surface and the normalized intensity in the bottom surface is 0.35 or less;

the [¹H⁻/³⁰Si⁻] profile being a ratio of a profile of a secondary ion intensity of hydrogen H measured under the following analysis conditions to a profile of a secondary ion intensity of silicon isotope ³⁰Si measured under the following analysis conditions, and the normalized intensity corresponding to the normalized hydrogen concentration:

### (Analysis Conditions)

Measuring apparatus: Secondary ion mass spectrometer having quadrupole mass analyzer;

Primary ion species: Cs⁺;

Primary accelerated voltage: 5.0 kV;

Primary ion current: 1 μA;

Primary ion incidence angle (angle from vertical direction of sample surface): 60°;

Luster size: 200×200 μm²;

Detection region: 40×40 μm²;

Secondary ion polarity: Minus; and

Use of electron gun for neutralization: Yes.

3. A float glass for chemical strengthening, having a bottom surface to contact a molten metal during molding and a top surface facing the bottom surface, wherein a ratio of an average H/Si intensity at a depth of 5 to 10 μm in the bottom surface to the average H/Si intensity at a depth of 5 to 10 μm in the top surface is 1.65 or less.

4. A float glass for chemical strengthening, having a bottom surface to contact a molten metal during molding and a top surface facing the bottom surface, wherein a ratio of a β-OH in a surface layer at a depth of 5 to 30 μm in the bottom surface to the β-OH in a surface layer at a depth of 5 to 30 μm in the top surface (β-OH in surface layer of bottom surface/β-OH in surface layer of top layer) is 1.27 or less.

5. A float glass for chemical strengthening, having a bottom surface to contact a molten metal during molding and a top surface facing the bottom surface, wherein a ratio of a β-OH in a surface layer, calculated by the following steps (1) to (3), at a depth of 5 to 30 μm in the bottom surface to the β-OH in a surface layer at a depth of 5 to 30 μm in the top surface β-OH in surface layer of bottom surface/β-OH in surface layer of top layer), is 1.27 or less.

(1) A measuring surface of the float glass is polished to a removal of 5 μm and is subjected to IR measurement, and an absorbance of Si—OH peak present in the vicinity of 3,500 cm⁻¹ is calculated by subtracting an absorbance based on 3,955 cm⁻¹ from an absorbance of Si—OH peak top.

(2) The measuring surface of the float glass is further polished to a removal of 25 μm, and the absorbance of Si—OH peak is measured in the same manner as in the step (1).

(3) The β-OH in a surface layer in a target region is calculated by the following formula, from a difference between the absorbance of Si—OH peak before polishing and the absorbance of Si—OH peak after polishing obtained from the steps (1) and (2), and a thickness removed by polishing:

(β-OH in surface layer)=[(Si—OH absorbance of 5 μm polished surface)−(Si—OH absorbance of 30 μm polished surface)]/(thickness removed by polishing (mm)).

6. A method for producing a chemically strengthened float glass, comprising chemically strengthening a float glass having a bottom surface to contact a molten metal during molding and a top surface facing the bottom surface, wherein, in the float glass, an absolute value of a difference between a normalized hydrogen concentration at a depth of 5 to 10 μm that is a value obtained by dividing a hydrogen concentration at a depth of 5 to 10 μm by a hydrogen concentration at a depth of 50 to 55 μm in the top surface and the normalized hydrogen concentration at a depth of 5 to 10 μm in the bottom surface is 0.35 or less;

the hydrogen concentration at a depth of 5 to 10 μm and the hydrogen concentration at a depth of 50 to 55 μm being values (average values) measured under the following analysis conditions, respectively:

### (Analysis Conditions)

Measuring apparatus: Secondary ion mass spectrometer having quadrupole mass analyzer;

Primary ion species: Cs⁺;

Primary accelerated voltage: 5.0 kV;

Primary ion current: 1 μA;

Primary ion incidence angle (angle from vertical direction of sample surface): 60°;

Luster size: 200×200 μm²;

Detection region: 40×40 μm²;

Secondary ion polarity: Minus; and

Use of electron gun for neutralization: Yes.

7. A method for producing a chemically strengthened float glass, comprising chemically strengthening a float glass having a bottom surface to contact a molten metal during molding and a top surface facing the bottom surface, wherein regarding a normalized intensity at a depth of 5 to 10 μm that is a value obtained by dividing, in [¹H⁻/³⁰Si⁻] profile of the float glass, [¹H⁻/³⁰Si⁻] at a depth of 5 to 10 μm by [¹H⁻/³⁰Si⁻] at a depth of 50 to 55 μm, measured under the following analysis conditions, an absolute value of a difference between the normalized intensity in the top surface and the normalized intensity in the bottom surface is 0.35 or less:

### (Analysis Conditions)

Measuring apparatus: Secondary ion mass spectrometer having quadrupole mass analyzer;

Primary ion species: Cs⁺;

Primary accelerated voltage: 5.0 kV;

Primary ion current: 1 μA;

Primary ion incidence angle (angle from vertical direction of sample surface): 60°;

Luster size: 200×200 μm²;

Detection region: 40×40 μm²;

Secondary ion polarity: Minus; and

Use of electron gun for neutralization: Yes.

8. A method for producing a float glass for chemically strengthening, the float glass for chemically strengthening having a bottom surface to contact a molten metal during molding and a top surface facing the bottom surface, wherein a ratio of an average H/Si intensity at a depth of 5 to 10 μm in the bottom surface to the average H/Si intensity at a depth of 5 to 10 μm in the top surface is 1.65 or less.

9. A method for producing a chemically strengthened float glass, comprising chemically strengthening a float glass having a bottom surface to contact a molten metal during molding and a top surface facing the bottom surface, wherein, in the float glass, a ratio of a β-OH in a surface layer at a depth of 5 to 30 μm in the bottom surface to the β-OH in a surface layer at a depth of 5 to 30 μm in the top surface (β-OH in surface layer of bottom surface/β-OH in surface layer of top layer) is 1.27 or less.

10. The method for producing a chemically strengthened float glass according to any one of the above 6 to 9, wherein a surface compressive stress of the chemically strengthened float glass is 600 MPa or more, and a depth of a surface compressive stress layer of the chemically strengthened float glass is 15 μm or more.

### Advantages of the Invention

In the float glass for chemical strengthening of the present invention, the difference in hydrogen concentration between the top surface and the bottom surface is small. Therefore, warpage of the float glass after chemical strengthening can be reduced and excellent flatness can be obtained, even though polishing treatment or the like before chemical strengthening is simplified or omitted, without decreasing a stress by chemical strengthening.

### BRIEF DESCRIPTION OF THE DRAWINGS

FIG. 1 is a vertically cross-sectional view of a production apparatus of the float glass for chemical strengthening of the present invention.

FIG. 2 is a cross-sectional view of a flat panel display in which the float glass for chemical strengthening of the present invention which has been chemically strengthened is used as a cover glass for a flat panel display.

FIG. 3 is a view showing [¹H⁻/³⁰Si⁻] profile by secondary ion mass spectrometer of a float glass of Comparative Example 1 (glass material B). In FIG. 3, surface T is a top surface, and surface B is a bottom surface.

FIG. 4 is a view showing the result that a top surface of a float glass of Comparative Example 1 (glass material B) was etched to various depths, the float glass having the top surface etched was chemically strengthened, and the difference in the amount of warpage before and after chemical etching (Δ warpage amount 1) was measured.

FIGS. 5(a) to 5(d) are views showing [¹H⁻/³⁰Si⁻] profiles by secondary ion mass spectrometer of the float glass used in each of Comparative Example 1 (FIG. 5(a)), Example 1 (FIG. 5(b)), Comparative Example 2 (FIG. 5(c)), and Comparative Example 3 (FIG. 5(d)).

FIG. 6 is a view showing an outline of a polishing IR method.

FIG. 7 is a view in which β-OH in a region of a depth of 0 to 40 μm was calculated and compared with 1H/30Si average count in the same region calculated from SIMS method. In FIG. 7, β-OH was calculated by a mass conversion method. In FIG. 7, reading error is ±2.5 to 3.5%. In the graph of FIG. 7, y=2.0977×+0.0566, and R²=0.985.

FIG. 8 is a view showing the correlation between β-OH in a surface layer and Δ warpage amount 2 described hereinafter.

FIG. 9 is a view showing H/Si intensity profile measured under the analysis condition A (Example 3).

FIG. 10 is a view showing H/Si intensity profile measured under the analysis condition B (Example 3).

### MODE FOR CARRYING OUT THE INVENTION

### 1. Evaluation of Hydrogen Concentration by SIMS Analysis

### 1A. Evaluation of Hydrogen Concentration by Normalized Hydrogen Concentration

The float glass for chemical strengthening of the present invention is formed by a float process, and has a bottom surface to contact a molten metal during molding and a top surface facing the bottom surface. The present inventors have found that the main reason of warpage caused by chemical strengthening of a float glass is due to the difference in hydrogen concentration between the top surface and the bottom surface as described below.

In the production of a glass by a float process, a sheet glass is produced by continuously feeding a molten glass to a surface of a molten metal retained in a float bath from an upstream side to form a glass ribbon, and drawing the glass ribbon after molding from an edge of a downstream side of the float bath, and annealing the glass ribbon by a lehr.

The production of a glass by the float process generally uses an apparatus of a type having a flow passage narrowed down, in which a glass tank furnace is connected to a float bath through a canal and a spout.

In this case, the glass is required to be spread in a float bath. Therefore, a molten glass having higher temperature as compared with the case of an apparatus of other type described hereinafter is flow-cast on the surface of a molten metal, and molded.

However, a dew point in the float bath is low. Therefore, H₂O diffuses from the glass surface, H₂O diffuses in the atmosphere from the top surface, and H₂O diffuses in the molten metal from the bottom surface. For this reason, in the float glass produced by the apparatus of this type, the hydrogen concentration in the surface (5 to 10 μm) is small as compared with the hydrogen concentration in the inside (typically a depth of about 50 μm or more). Diffusion coefficient of H₂O is high when a temperature is high. Therefore, the amount of diffusion of H₂O from the top surface facing the atmosphere having a dew point lower than or a temperature higher than that of the bottom surface of the float glass facing the molten metal having lower temperature is increased, and the hydrogen concentration in the top surface of the float glass is lower than that of the bottom surface thereof.

Where the hydrogen concentration in a glass is high, hydrogen enters bonding network of Si—O—Si of a glass in the form of SiOH, and the Si—O—Si bond breaks. Where the hydrogen concentration in a glass is high, a portion in which Si—O—Si bond breaks is increased, and thermal characteristics such as glass transition temperature are deteriorated. As a result, the stress is relaxed in chemical strengthening in which a glass is heated at high temperature, and the stress is decreased.

As a result, of the top surface and the bottom surface in the float glass, the degree of behavior of stress during chemical strengthening is small in a glass surface having a high hydrogen concentration, and the degree of behavior of the stress during chemical strengthening is high in a glass surface having a low hydrogen concentration.

In other words, it is considered that if a float glass in which the hydrogen concentration in the top surface is lower than that in the bottom surface is chemically strengthened, the degree of behavior of the stress is high in the top surface having the low hydrogen concentration in comparison with the bottom surface having the high hydrogen concentration, a glass warps so as to project toward a top surface side, and warpage is generated.

Therefore, the degree of behavior of stress approaches a balanced state between the top surface and the bottom surface after chemical strengthening as the hydrogen concentration in the top surface of the float glass is closer to that in the bottom surface thereof, that is, an absolute value of the difference in hydrogen concentration between the top surface and the bottom surface becomes smaller, and as a result, warpage is reduced.

In the present invention, it is difficult to measure the hydrogen concentration itself and the difference itself in hydrogen concentration with good precision. Therefore, the [¹H⁻/³⁰Si⁻] proportional to the hydrogen concentration is used as a direct index of the hydrogen concentration, and the “difference in the normalized hydrogen concentration between the top surface and the bottom surface” and the “difference in the normalized intensity between the top surface and the bottom surface” that are proportional to the above-described difference in hydrogen concentration are used as a direct index of the difference in hydrogen concentration.

In the present specification, the [¹H⁻/³⁰Si⁻] means a value measured under the following analysis conditions.

### (Analysis Conditions)

Measuring apparatus: Secondary ion mass spectrometer having quadrupole mass analyzer

Primary ion species: Cs⁺

Primary accelerated voltage: 5.0 kV

Primary ion current: 1 μA

Primary ion incidence angle (angle from vertical direction of sample surface): 60°

Luster size: 200×200 μm²

Detection region: 40×40 μm²

Secondary ion polarity: Minus

Use of electron gun for neutralization: Yes

The [¹H⁻/³⁰Si⁻], normalized intensity and normalized hydrogen concentration are described below. Secondary ion intensity I_{M1} of an isotope M₁ of an element M in secondary ion mass spectrometry is proportional to primary ion intensity I_{P}, sputtering rate Y of a matrix, concentration C_{M} of the element M (ratio to total concentration), existence probability α₁ of the isotope M₁, secondary ionization rate β_{M} of the element M, and transmission efficiency η (including detection efficiency of detector) of mass spectrometer.

I_{M1}=A·I_{P}·Y·C_{M}·α₁·β_{M}·η (Formula 1)

The “A” is a ratio of detection area of secondary ion to scanning range of primary ion beam.

In general, because it is difficult to obtain η of an apparatus, an absolute value of β_{M} cannot be obtained. Therefore, an element of a main component in the same sample is used as a reference element, and η is eliminated by employing a ratio to the (Formula 1).

When a reference element is R and its isotope is Rⱼ, (Formula 2) is obtained.

I_{M1}/I_{Rj}=(C_{M}·α₁·β_{M})/(C_{R}·αⱼ·β_{R})=C_{M}/K (Formula 2)

wherein K is a relative sensitivity factor of element M to element R.

K=(C_{R}·αⱼ·β_{R})/(α₁·β_{M}) (Formula 3)

In this case, the concentration of element M is obtained from (Formula 4).

C_{M}=K·I_{M1}/I_{Rj} (Formula 4)

In the present invention, ¹H⁻ corresponds to M₁, and ³⁰Si⁻ corresponds to Rⱼ. Therefore, from the (Formula 2), intensity ratio [¹H⁻/³⁰Si⁻] of those equals to a value obtained by dividing hydrogen concentration C_{H} by K. That is, the [¹H⁻/³⁰Si⁻] is a direct index of the hydrogen concentration.

The normalized intensity is a value obtained by dividing [¹H⁻/³⁰Si⁻] at a certain depth x by [¹H⁻/³⁰Si⁻] at a depth of 50 to 55 μm, that is, a value obtained by dividing C_{H}/K at a certain depth x by C_{H}/K at a depth of 50 to 55 μm. Because K is eliminated, the normalized intensity is the same as a value obtained by dividing C_{H} at a depth x by C_{H} at a depth of 50 to 55 μm, that is, normalized hydrogen concentration at a depth x.

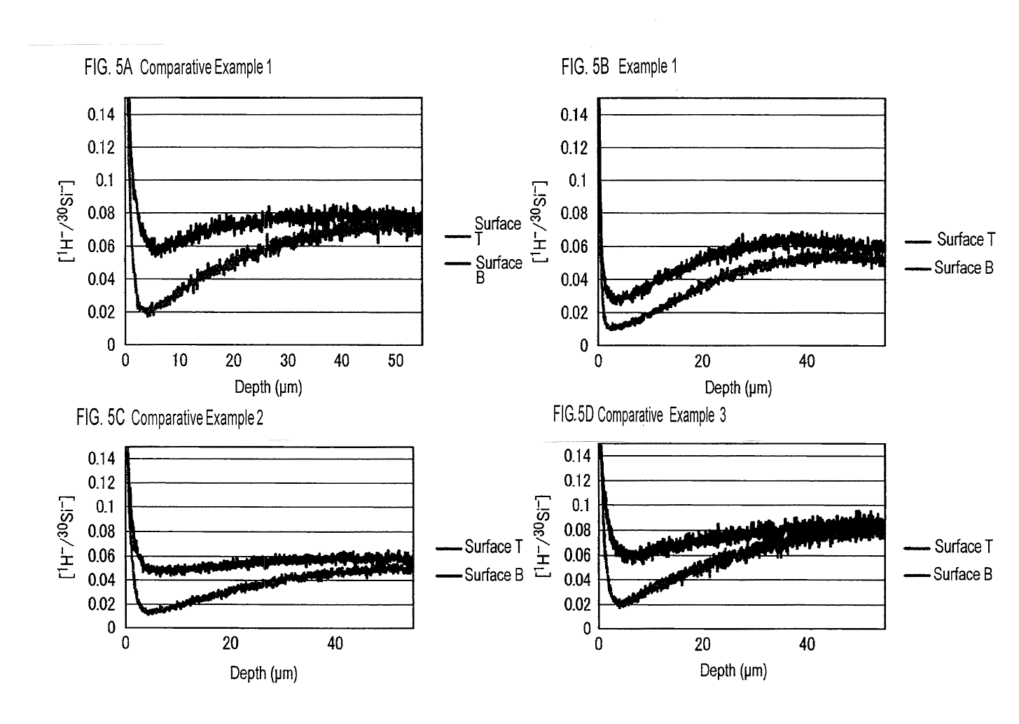

The reason that the hydrogen concentration at a depth of 50 to 55 μm is used as the basis in calculating the normalized hydrogen concentration is that a region of a depth of 50 to 55 μm is considered to be an inner region in which the hydrogen concentration does not fluctuate, and each profile in FIG. 5 serves as the basis of this standpoint.

An absolute value of the difference in normalized intensity between the top surface and the bottom surface in the float glass is obtained by, for example, the following procedures (i) to (iii) by secondary ion mass spectrometry (SIMS analysis). The analysis conditions described blow are exemplification, and should be appropriately changed depending on a measuring apparatus, a sample and the like.

(i) Secondary ion mass spectrometry is applied to each of a top surface and a bottom surface up to a depth of 60 μm from a surface layer under the following analysis conditions.

### (Analysis Conditions)

Measuring apparatus: Secondary ion mass spectrometer having quadrupole mass analyzer

Primary ion species: Cs⁺

Primary accelerated voltage: 5.0 kV

Primary ion current: 1 μA

Primary ion incidence angle (angle from vertical direction of sample surface): 60°

Luster size: 200×200 μm²

Detection region: 40×40 μm²

Secondary ion polarity: Minus

Use of electron gun for neutralization: Yes

In the case where the intensity of ³⁰Si⁻ at a depth of 55 μm is smaller than the intensity of ³⁰Si⁻ at a depth of 5 μm by more than 3%, it is preferred to analyze a sample in which the surface of a glass substrate has been previously etched to a removal of about 45 μm.

More specific analysis conditions are, for example, as follows.

### (Analysis Conditions)

Measuring apparatus: Secondary ion mass spectrometer having quadrupole mass analyzer

Primary ion species: Cs⁺

Primary accelerated voltage: 5.0 kV

Primary ion current: 1 μA

Primary ion incidence angle (angle from vertical direction of sample surface): 60°

Luster size: 200×200 μm²

Detection region: 40×40 μm²

Sputtering rate: 14 nm/sec

Secondary ion polarity: Minus

Use of electron gun for neutralization: Yes

Examples of the secondary ion mass spectrometer having quadrupole mass analyzer include ADEPT 1010, manufactured by Ulvac-Phi, Inc.

(ii) A value obtained by dividing, in [¹H⁻/³⁰Si⁻] profile obtained by secondary ion mass spectrometry, [¹H⁻/³⁰Si⁻] at a depth of 5 to 10 μm by [¹H⁻/³⁰Si⁻] at a depth of 50 to 55 μm is defined as the normalized intensity at a depth of 5 to 10 μm in secondary ion mass spectrometry.

(iii) Regarding the normalized intensity at a depth of 5 to 10 μm obtained by secondary ion mass spectrometry, an absolute value of the difference between the top surface and the bottom surface is calculated.

Regarding the normalized intensity or normalized hydrogen concentration at a depth of 5 to 10 μm obtained by secondary ion mass spectrometry, in the float glass of the present invention, the absolute value of the difference between the top surface and the bottom surface is 0.35 or less, more preferably 0.32 or less, still more preferably 0.30 or less, particularly preferably 0.28 or less, and most preferably 0.26 or less.

Regarding the normalized intensity or normalized hydrogen concentration at a depth of 5 to 10 μm obtained by secondary ion mass spectrometry, if the difference between the top surface and the bottom surface is 0.35 or less, the warpage of a float glass after chemical strengthening is reduced and excellent flatness can be obtained, even though polishing treatment or the like before chemical strengthening is simplified or omitted.

The method for evaluating the hydrogen concentration by the normalized hydrogen concentration in “1A” can shorten the measurement time as compared with the method for evaluating the hydrogen concentration by an average H/Si intensity described in “1B”, and is preferably used in the case where prompt measurement is required. Particularly, a precise value is obtained to some extent in the hydrogen concentration to a depth of 30 μm from a surface layer.

### 1B. Evaluation of Hydrogen Concentration by Average H/Si Intensity

As described in “1A”, the evaluation by the normalized hydrogen concentration as described above is effective for the above-described evaluation of dehydration state of a float glass surface. However, resolution in a depth direction of SIMS profile and repeated measurement accuracy are improved by evaluating the hydrogen concentration by an average H/Si intensity.

The degree of behavior of stress approaches an equilibrium state between the top surface and the bottom surface after chemical strengthening as the hydrogen concentration in the top surface of the float glass is close to that in the bottom surface thereof, that is, the hydrogen concentration ratio between the top surface and the bottom surface approaches 1, and then, warpage is reduced.

In the present invention, it is difficult to measure the hydrogen concentration itself and the hydrogen concentration ratio itself with good accuracy. Therefore, the average H/Si intensity proportional to the hydrogen concentration is used as a direct index of the hydrogen concentration, and the “ratio of the average H/Si intensity in the bottom surface to that in the top surface” proportional to the hydrogen concentration is used as a direct index of the hydrogen concentration ratio.

The ratio of the average H/Si intensity in the bottom surface to that in the top surface in the float glass is obtained by, for example, the following procedures (I) and (II) by secondary ion mass spectrometry (SIMS analysis). The analysis conditions shown below are exemplification, and should be appropriately changed depending on a measuring apparatus, a sample or the like.

(I) Secondary ion mass spectrometry is applied to a top surface and a bottom surface, respectively, to a depth of 5 to 10 μm from a surface under the following analysis conditions.

### (Analysis Conditions)

Measuring apparatus: Secondary ion mass spectrometer having quadrupole mass analyzer

Primary ion species: Cs⁺

Primary accelerated voltage: 5.0 kV

Primary ion current: 1 μA

Primary ion incidence angle (angle from vertical direction of sample surface): 60°

Luster size: 400×400 μm²

Detection region: 40×40 μm²

Secondary ion polarity: Minus

Use of electron gun for neutralization: Yes

Field Aperture of detector: 1

ESA Input Lens of detector: 0

Example of the secondary ion mass spectrometer having quadrupole mass analyzer include ADEPT1010, manufactured by Ulvac-Phi, Inc.

If the luster size of primary ion is 400×400 μm², the field aperture of the detector is 1 and ESA input lens of the detector is 0, the detection of crater edge component is suppressed, and this enables measurement with high accuracy.

(II) Regarding the average H/Si intensity at a depth of 5 to 10 μm in H/Si intensity profile obtained by secondary ion mass spectrometry in (I), a ratio of that in the bottom surface to that in the top surface is calculated.

In the float glass of the present invention, regarding the average H/Si intensity at a depth of 5 to 10 μm, the ratio of that in the bottom surface to that in the top surface is 1.65 or less, more preferably 1.60 or less, and still more preferably 1.55 or less.

Regarding the average H/Si intensity at a depth of 5 to 10 μm, when the ratio of that in the bottom surface to that in the top surface is 1.65 or less, warpage of the float glass after chemical strengthening can be reduced and excellent flatness can be obtained, even though polishing treatment or the like before chemical strengthening is simplified or omitted.

As compared with the method for evaluating the hydrogen concentration by the normalized hydrogen concentration in “1A”, the method for evaluating the hydrogen concentration by the average H/Si intensity in “1B” can suppress the detection of a crater edge component or knock-on effect and resolution in a depth direction of SIMS profile and repeated measurement accuracy can be improved. The crater edge component used herein means a secondary ion released from an edge part of an analyzed crater, and by suppressing the detection of the crater edge component, an accurate hydrogen concentration at a certain depth can be obtained. The knock-on effect is a phenomenon that atoms in a sample rebound by primary ions, and by suppressing the knock-on effect, precipitous property of SIMS profile is improved.

### 2. Evaluation of Hydrogen Concentration by β-OH in Surface Layer

The evaluation by the normalized hydrogen concentration is effective for the evaluation of dehydration state of a float glass surface as described above, but the evaluation of the hydrogen concentration by β-OH in a surface layer is preferred in that the error range is further narrow.

There is β-OH measured by IR method as an index of the amount of water in a glass. The β-OH measurement is mainly a method that is applied to a bulk plate, and the evaluation can be performed in a short period time, in a simple manner and with high accuracy. However, the β-OH in a region of several tens μm on a glass surface has not been measured.

If the β-OH in the region can be measured by IR method, it can be expected that many samples can be analyzed by general-purpose apparatuses with good accuracy. Therefore, the present inventors have developed a polishing IR method and have investigated on the measurement of β-OH on a glass surface (β-OH in a surface layer).

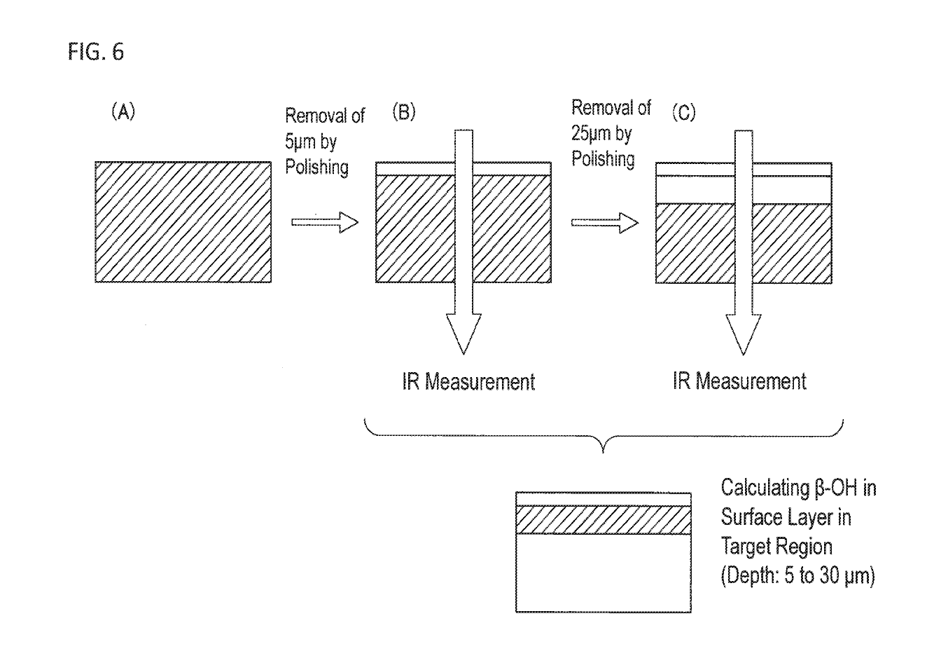

The summary of the polishing IR method is described below (FIG. 6). In the polishing IR method, a region on which β-OH on a glass substrate surface is desired to be evaluated is removed by polishing treatment, the substrate before and after polishing is subjected to IR measurement, and absorbance of Si—OH peak detected in the vicinity of 3,500 cm⁻¹ is read.

The β-OH in the target region is calculated from the difference in absorbance of Si—OH peak before and after polishing and the polishing thickness. As compared with the case of the sample before polishing, in the sample after polishing, the decrease in intensity of Si—OH peak is confirmed. The decreased portion corresponds to absorption of a glass in a region polished.

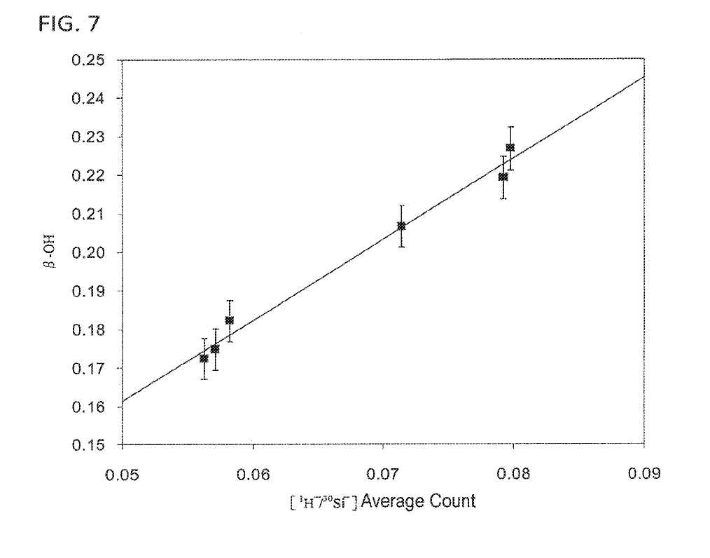

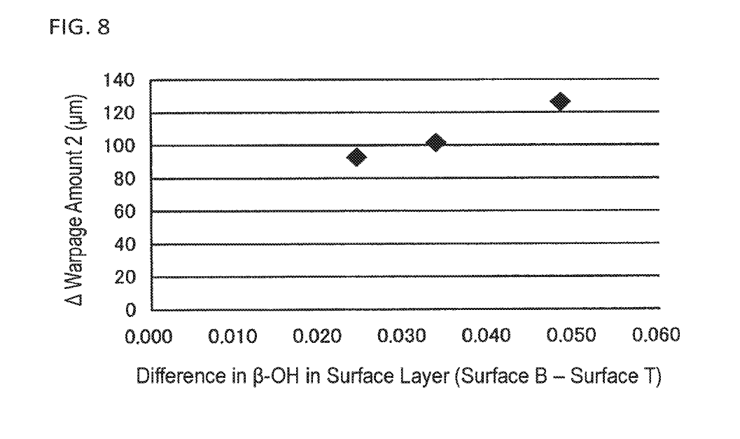

The absorbance of Si—OH peak present in the vicinity of 3,500 cm⁻¹ is calculated by subtracting the absorbance based on 3,955 cm⁻¹ from the absorbance of Si—OH peak top. FIG. 7 shows the comparison with 1H/30Si average count of the same region obtained by calculating β-OH in a region of a depth of 0 to 40 μm and calculating from SIMS method. Positive correlation is present between β-OH and [¹H⁻/³⁰Si⁻] average count. Therefore, the β-OH in a surface layer calculated by a polishing IR method can be used for the evaluation of the hydrogen concentration on a glass surface, similar to SIMS method.

In the present invention, dehydration state of the top surface and bottom surface of the float glass is specifically evaluated by obtaining β-OH in a surface layer at a depth of 5 to 30 μm calculated by the following steps (1) to (3).

(1) Measuring surface of the float glass is polished to a removal of 5 μm, and then is subjected to IR measurement. Absorbance of Si—OH peak is calculated by subtracting the absorbance based on 3,955 cm⁻¹ from the absorbance of Si—OH peak top (FIG. 6B). The absorbance of Si—OH peak top is absorbance present in the vicinity of 3,500 cm⁻¹.

(2) The measuring surface of the float glass is further polished to a removal of 25 μm, and absorbance of Si—OH peak is measured in the same manner as in step (1) (FIG. 6C).

(3) The β-OH in a surface layer of a target region is calculated by the following formula from the difference in absorbance of Si—OH peak before and after polishing and the polished thickness obtained in the steps (1) and (2).

(β-OH in surface layer)=[(Si—OH absorbance of 5 μm removal by polishing)−(Si—OH absorbance of 30 μm removal by polishing)]/(polished thickness (mm))

In the surface (depth: 0 to several μm) of the float glass, Si—O—Na⁺ is small by burning. For this reason, there is a possibility that the absorbance in the peak top in the vicinity of 3,500 cm⁻¹ used in the calculation of β-OH differs between the surface of the float glass and the bulk thereof. Therefore, where IR spectrum of the surface of the float glass is used for the calculation of β-OH, the hydrogen concentration cannot be correctly evaluated. According to the polishing IR method that is the method for measuring β-OH in a surface layer of the present invention, a sample in which the surface has been removed can be evaluated by conducting IR measurement after polishing the measuring surface of the float glass to a removal of 5 μm.

It is preferred in the above steps (1) to (3) that the same glass substrates are polished to prepare the samples (A) to (C) shown in FIG. 6, and β-OH in a surface layer is calculated from IR spectrum of the samples (B) and (C) in FIG. 6. Alternatively, a plurality of the same glass substrates are prepared, the samples (B) and (C) in FIG. 6 are prepared by changing polished thickness, and IR measurement and β-OH calculation may be performed.

Examples of an abrasive used for polishing include CeO₂, SiO₂, Al₂O₃ and ZrO₂.

Examples of the method for calculating polished thickness include a mass conversion method that calculates polished thickness from the difference in mass of a glass sheet before and after polishing, and a sheet thickness conversion method that calculates from the difference in sheet thickness before and after polishing. The sheet thickness conversion method measures the sheet thickness by a thickness meter, whereas the mass conversion method measures mass of a glass by an electronic balance.

Considering accuracy of the thickness meter and the electronic balance, the mass conversion method can calculate the average polished thickness of the glass sheet with higher accuracy. Therefore, in the present invention, it is preferred that the polished thickness is calculated by the mass conversion method that calculates the polished thickness from the difference in mass of the glass sheet before and after polishing.

Alternatively, a laser thickness meter may be used.

In the present invention, the ratio of β-OH in a surface layer at a depth of 5 to 30 μm in the bottom surface, obtained by the steps (1) to (3), to the β-OH in a surface layer at a depth of 5 to 30 μm in the top surface (β-OH in surface layer of bottom surface/β-OH in surface layer of top surface) is 1.27 or less, preferably 1.25 or less, and more preferably 1.23 or less.

Where the ratio of the β-OH in a surface layer at a depth of 5 to 30 μm in the bottom surface to the β-OH in a surface layer at a depth of 5 to 30 μm in the top surface exceeds 1.27, there is a possibility that warpage is generated in the float glass after chemical strengthening. If the ratio of β-OH in a surface layer at a depth of 5 to 30 μm in the bottom surface to the β-OH in a surface layer at a depth of 5 to 30 μm in the top surface is 1.27 or less, warpage of the float glass after chemical strengthening is reduced and excellent flatness can be obtained, even though polishing treatment or the like before chemical strengthening is simplified or omitted.

The IR measurement is conducted by the conventional method using the commercially available apparatus (for example, Nicolet 6700, manufactured by Thermo Fisher Scientific).

### 3. Production Method of Glass

As the method for decreasing the difference in hydrogen concentration between the top surface and the bottom surface in the float glass, that is, regarding the normalized intensity or normalized hydrogen concentration, at a depth of 5 to 10 μm obtained by the secondary ion mass spectrometry, the method for further decreasing an absolute value of the difference between the top surface and the bottom surface, the method for approaching a ratio of the average H/Si intensity in the bottom surface to the average H/Si intensity in the top surface to 1 as possible, and the method for decreasing the difference in water amount between the top surface and the bottom surface in the float glass, that is, the method for further decreasing a ratio of the β-OH in a surface layer at a depth of 5 to 30 μm in the bottom surface to the β-OH in a surface layer at a depth of 5 to 30 μm in the top surface (β-OH in surface layer of bottom surface/β-OH in surface layer of top surface), examples thereof include the following methods (1) to (6). Those methods may be used alone or in combination of those.

(1) Raw material containing hydrogen such as hydroxide is replaced by raw material free of hydrogen to decrease the original hydrogen concentration in a glass.

(2) The difference in temperature between a molten glass flown in a float bath and a molten metal in an upper stream of a float bath is decreased.

(3) Water vapor is flown to an upper stream of a float bath.

(4) Water vapor is sprayed to a top surface side by a lehr.

(5) SO₂ is sprayed to a top surface side by a lehr.

(6) Residence time of a molten glass in a float bath is shortened.

The above (2) is specifically described. The present inventors have found that diffusion of H₂O in the atmosphere or a molten metal from a float glass is dominated by a temperature. Conventionally, in a float method of a type in which a glass tank furnace is connected to a float bath through a canal and a spout, a molten glass having relatively high temperature flows on a molten metal having relatively low temperature, and as a result, the amount of diffusion of H₂O from a top surface side is larger than the amount of diffusion of H₂O from a bottom surface. Therefore, according to float molding in which a molten glass having a temperature lower than the conventional temperature is cast on a molten metal having a temperature higher than the conventional temperature, a float glass having small warpage after chemical strengthening can be produced.

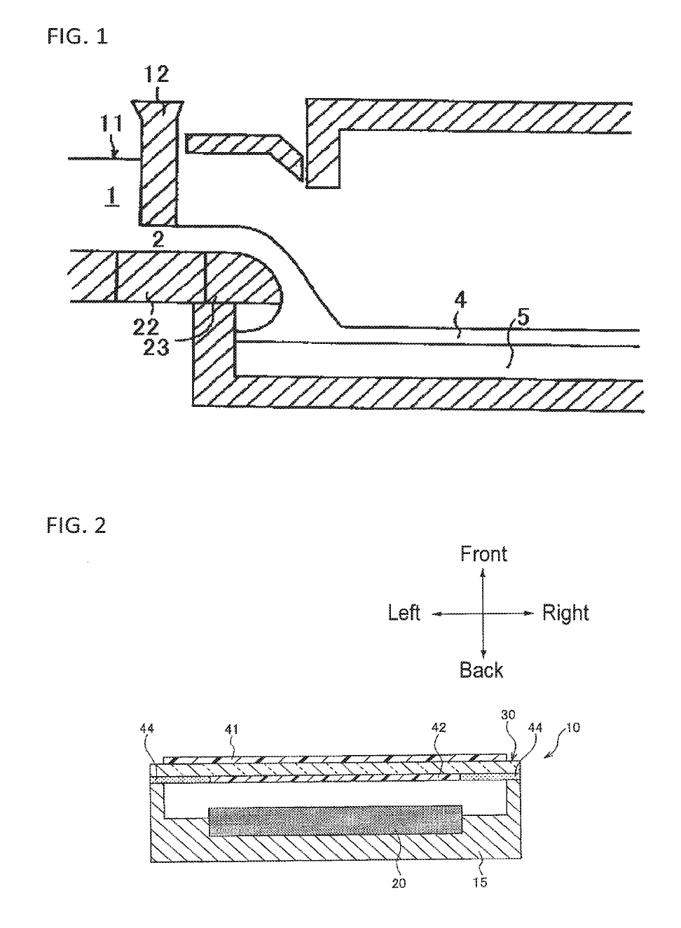

The present invention is described below based on the drawings, but the invention is not limited to those. FIG. 1 is a vertically cross-sectional view of a production apparatus of a float glass in the present invention. In FIG. 1, 12 is a weir, 22 is a fixed refractory located below the weir, and 23 is a lip of a spout.

Although not omitted in the drawing, raw material is continuously supplied to a glass tank furnace to melt the raw material at high temperature region in the glass tank furnace, and a molten glass obtained is guided to a cooling region to adjust the temperature. A molten glass 1 having adjusted temperature passes through a connection groove 11, and passes through a space 2 formed by the weir 12 and the fixed refractory 22 located below the weir 12. The molten glass 1 is then supplied to a molten metal bath 5 through the lip 23 of a spout and molded into a glass ribbon 4.

It is preferred that the difference between the temperature of the molten glass 1 located in the uppermost stream (1 Bay) of a float bath and the temperature of the molten metal bath 5 is decreased, although the difference was conventionally 100° C. or higher.

More specifically, an absolute value in the difference between the temperature (t1) of the molten glass 1 located in the uppermost stream (1 Bay) of a float bath and the temperature (t2) of the molten metal bath 5 is preferably 80° C. or lower, and more preferably 70° C. or lower. If the temperature difference is 80° C. or lower, the difference in hydrogen concentration between the top surface and the bottom surface can be decreased.

The above (6) is specifically described. Dehydration from a glass top surface in a float bath follows a diffusion equation. Therefore, if a glass temperature in the float bath is further decreased and a residence time of a glass in a high temperature region is further shortened, dehydration from the top surface is suppressed, and as a result, the difference in β-OH in a surface layer on a glass surface between the top surface and the bottom surface is reduced, thereby the amount of warpage can be reduced.

In other words, a glass ribbon width is not widened in the upper portion of the bath, the glass ribbon quickly is sent to a downstream side by, for example, increasing line speed, the glass ribbon width is widened in middle and downstream areas, and a sheet thickness is controlled within a given range.

The float glass has a thickness of preferably 1.5 mm or less, and more preferably 1.1 mm or less. Typically, the thickness is 0.7 mm or more, but a float glass having a thickness smaller than 0.7 mm is used as necessary.

In the float glass for chemical strengthening of the present invention, warpage after chemical strengthening can be reduced regardless of a composition. As the composition of the float glass for chemical strengthening, examples thereof include the following glass compositions.

(i) A glass containing, in a composition in terms of mol %, 50 to 80% of SiO₂, 2 to 25% of Al₂O₃, 0 to 10% of Li₂O, 0 to 18% of Na₂O, 0 to 10% of K₂O, 0 to 15% of MgO, 0 to 5% of CaO and 0 to 5% of ZrO₂.

(ii) A glass containing, in a composition in terms of mol %, 50 to 74% of SiO₂, 1 to 10% of Al₂O₃, 6 to 14% of Na₂O, 3 to 11% of K₂O, 2 to 15% of MgO, 0 to 6% of CaO and 0 to 5% of ZrO₂, provided that the total content of SiO₂ and Al₂O₃ is 75% or less, the total content of Na₂O and K₂O is 12 to 25%, and the total content of MgO and CaO is 7 to 15%.

(iii) A glass containing, in a composition in terms of mol %, 68 to 80% of SiO₂, 4 to 10% of Al₂O₃, 5 to 15% of Na₂O, 0 to 1% of K₂O, 4 to 15% of MgO and 0 to 1% of ZrO₂.

(iv) A glass containing, in a composition in terms of mol %, 67 to 75% of SiO₂, 0 to 4% of Al₂O₃, 7 to 15% of Na₂O, 1 to 9% of K₂O, 6 to 14% of MgO and 0 to 1.5% of ZrO₂, provided that the total content of SiO₂ and Al₂O₃ is 71 to 75%, the total content of Na₂O and K₂O is 12 to 20%, and the content of CaO if contained is less than 1%.

The float glass molded is cut into a given size by a cutter not shown, and then is chemically strengthened. Thus, a chemically strengthened float glass can be obtained.

The chemical strengthening is a treatment of forming a compressive stress layer on a glass surface by exchanging an alkali metal ion having small ion radius (typically, Li ion or Na ion) on the glass surface with an alkali ion having larger ion radius (typically, K ion) by ion exchange at a temperature lower than a glass transition temperature. The chemical strengthening treatment can be carried out by the conventional method.

The float glass for chemical strengthening of the present invention is a float glass having a small amount of warpage after chemical strengthening. The amount of warpage of the float glass can be measured with a three-dimensional shape measuring instrument (for example, manufactured by Mitaka Kohki Co., Ltd.).

The amount of warpage is measured as the difference between the highest point and the lowest point when measured with a three-dimensional shape measuring instrument. The case where the float glass is warped in a convex direction of the top surface is expressed as “Plus”, and the case where the float glass is warped in a convex direction of the bottom surface is expressed as “Minus”.

The change of the amount of warpage of the float glass before and after chemical strengthening can be measured from Δ warpage amount [(amount of warpage after chemical strengthening)−(amount of warpage before chemical strengthening)]. The Δ warpage amount has nearly a proportional relationship to a degree of chemical strengthening [CS (compressive stress: surface compressive stress)×DOL (depth of layer: depth of compressive stress layer)], and in order to eliminate the influence of the difference in the degree of chemical strengthening (CS×DOL), it is preferred to compare them by dividing the Δ warpage amount by (CS×DOL).

In the present invention, the measurement is conducted by using the float glass of 5 cm square, and an absolute value of (Δ warpage amount 1)/(CS×DOL) [μm/(MPa·μm)] when converted into a thickness of 0.7 mm is preferably 0.001 or less, and more preferably 0.0007 or less. If the value is 0.001 or less, the warpage after chemical strengthening can be decreased.

Furthermore, in the present invention, the measurement is conducted by using the float glass of 10 cm square, and an absolute value of (Δ warpage amount 2)/(CS×DOL) [m/(MPa·μm)] when converted into a thickness of 0.7 mm is preferably 0.005 or less, and more preferably 0.0047 or less. If the value is 0.005 or less, the warpage after chemical strengthening can be decreased.

The CS (surface compressive stress) and DOL (depth of compressive stress layer) can be measured by a surface stress meter. The surface compressive stress of the chemically strengthened float glass is preferably 600 MPa or more, and the depth of the compressive stress layer is preferably 15 μm or more. If the surface compressive stress and the depth of the compressive stress layer of the chemically strengthened float glass fall within the above ranges, excellent scratch resistance is obtained.

An example where the float glass of the present invention which has been chemically strengthened is used as a cover glass for flat panel display is described below. FIG. 2 is a cross-sectional view of a display device in which a cover glass is arranged. In the following description, front-back and right-left are based on the direction of the arrow in the drawings.

As shown in FIG. 2, a display device 10 generally includes a display panel 20 provided in a chassis 15, and a cover glass 30 provided so as to cover the entire surface of the display panel 20 and to surround the front of the chassis 15.

The cover glass 30 is mainly arranged for the purpose of the improvement in beauty and strength of the display device 10, prevention of impact failure, and the like, and is formed from one sheet-shaped glass in which the entire shape is nearly flat surface shape. As shown in FIG. 2, the cover glass 30 may be arranged so as to depart from a display side (front side) of the display panel 20 (so as to have an air layer), and may be attached to a display side of the display panel 20 through an adhesive film (not shown) having translucency.

A functional film 41 is provided on the front surface of the cover glass 30 that emits light from the display panel 20, and a functional film 42 is provided on the back where light from the display panel 20 enters, at a position corresponding to the display panel 20. The functional films 41 and 42 are provided on both surfaces in FIG. 2, but the present invention is not limited to this case, and the functional film may be provided on the front or the back, or may be omitted.

The functional films 41 and 42 have functions of reflection prevention of surrounding light, prevention of impact failure, shielding of electromagnetic wave, shielding of near infrared ray, correction of color tone, and/or improvement of scratch resistance, and a thickness, a shape and the like are appropriately selected depending on the intended use. The functional films 41 and 42 are formed by, for example, attaching a film made of a resin to the cover glass 30. Alternatively, the functional films may be formed by a thin film formation method such as a deposition method, a sputtering method or a CVD method.

The reference numeral 44 is a black layer, and is, for example, a coating film formed by applying an ink containing pigment particles to the cover glass 30, and subjecting it to irradiation with ultraviolet ray, or heating and burning, followed by cooling. A display panel and the like become invisible from the outside of the chassis 15, thereby improving sensuousness of appearance.

### EXAMPLES

Examples of the present invention are specifically described below, but the present invention is not limited to those.

### Example 1

### (1) Production of Float Glass

Glass sheets of glass materials A to D having the following compositions were produced by a float process so as to have sheet thicknesses as shown in Table 1, and cut into a size of 50×50 mm to produce float sheet glass of Examples 1 and 2 and Comparative Examples 1 to 3.

### (Glass Material A)

A glass containing, in mol %, 73% of SiO₂, 7% of Al₂O₃, 14% of Na₂O and 6% of MgO.

### (Glass Material B)

A glass containing, in mol %, 64.3% of SiO₂, 8% of Al₂O₃, 12.5% of Na₂O, 4% of K₂O, 10.5% of MgO, 0.1% of CaO, 0.1% of SrO, 0.1% of BaO and 0.5% of ZrO₂.

### (Glass Material C)

A glass containing, in mol %, 71.5% of SiO₂, 1.8% of Al₂O₃, 12% of Na₂O, 0.9% of K₂O, 4.2% of MgO and 8.7% of CaO.

### (Glass Material D)

A glass containing, in mol %, 64.4% of SiO₂, 6% of Al₂O₃, 12% of Na₂O, 4% of K₂O, 11% of MgO, 0.1% of CaO, 0.1% of SrO and 0.5% of ZrO₂.

### (Glass Material E)

A glass containing, in mol %, 72.5% of SiO₂, 6.2% of Al₂O₃, 12.8% of Na₂O and 8.5% of MgO.

In FIG. 1, a temperature (t1) of the molten glass 1 in the uppermost stream (1 Bay) of a float bath during float molding, and a temperature (t2) of the molten metal bath 5 were measured, and an absolute value |t1−t2| of the difference between those was calculated. For example, regarding Example 1, an average value of the value obtained by measuring an ambient temperature above a spout lip with a thermocouple and the value obtained by measuring a temperature of a glass ribbon of 2 Bay with a radiation thermometer was defined as t1. Regarding Example 2, a glass ribbon temperature of 1 Bay was measured with a thermocouple, and defined as t1.

Regarding Comparative Examples 1 to 3, a value (t3) obtained by measuring a glass blank temperature in a canal with a thermocouple and a value (t4) obtained by measuring a temperature of a glass ribbon in 3 Bay with a radiation thermometer were used, and t1 was calculated using the following calculation formula.

t1=t3−(t3−t4)÷3

Regarding the temperature (t2) of a molten metal bath, an average value of values obtained by measuring a right side and a left side of 1 Bay with a thermocouple was used.

### (2) Secondary Ion Mass Spectrometry

Hydrogen concentration of each float glass of Examples 1 and 2 and Comparative Examples 1 to 3 was analyzed to a depth of 60 μm by secondary ion mass spectrometry.

Analysis conditions of the secondary ion mass spectrometry are as follows.

Measuring apparatus: ADEPT 1010, manufactured by Ulvac-Phi, Inc.

Primary ion species: Cs⁺

Primary accelerated voltage: 5.0 kV

Primary ion current: 1 μA

Primary ion incidence angle (angle from vertical direction of sample surface): 60°

Luster size: 200×200 μm²

Detection region: 40×40 μm²

Sputtering rate: 14 nm/sec

Secondary ion polarity: Minus

Use of electron gun for neutralization: Yes

[¹H/³⁰Si⁻] at a depth of 5 to 10 μm and at a depth of 50 to 55 μm was measured, and the difference between the normalized intensity at a depth of 5 to 10 μm in the bottom surface (surface B) and the normalized intensity at a depth of 5 to 10 μm in the top surface (surface T) was calculated.

Typically, field aperture of a detector is 1, and ESA input lens of a detector is 550.

### (3) Measurement of Amount of Warpage

After measuring the amount of warpage with a three-dimensional shape measuring instrument (NH-3MA) manufactured by Mitaka Kohki Co., Ltd.) before chemical strengthening, each float glass was chemically strengthened by a potassium nitrate molten salt under the conditions shown in Table 1, the amount of warpage after chemical strengthening was similarly measured, and Δ warpage amount=amount of warpage after chemical strengthening−amount of warpage before chemical strengthening was calculated. The Δ warpage amount in a float glass of 5 cm square was defined as Δ warpage amount 1.

Regarding the float glass after chemical strengthening, an average value of surface stress (CS) and a depth of compressive stress layer (DOL) were measured, and the average values in the top surface and in the bottom surface are shown in Table 1. The average value of surface stress (CS) and the depth of compressive stress layer were measured using a surface stress meter (FSM-6000LE), manufactured by Orihara Manufacturing Co., Ltd.

The Δ warpage amount 1 is inversely proportional to the square of a sheet thickness. Therefore, to eliminate influence of a sheet thickness, the Δ warpage amount 1 was converted into the case of the sheet thickness of 0.7 mm by the following calculation formula.

(Δ warpage amount 1′)=(Δ warpage amount 1)×(sheet thickness)²÷0.7²

Furthermore, because the Δ warpage amount 1 is proportional to the square of length of one side, Δ warpage amount 1″ that is an amount of warpage of 10 cm square and a sheet thickness of 0.7 mm can be calculated by the following formula.

(Δ warpage amount 1″)=(Δ warpage amount 1′)×10²÷5²

The Δ warpage amount 1 has nearly a proportional relationship to the degree of chemical strengthening (CS×DOL). Therefore, to eliminate the influence of the difference in the degree of chemical strengthening (CS×DOL), a value by dividing the Δ warpage amount by (CS×DOL) was calculated. When (Δ warpage amount 1′)/(CS×DOL) is 0.001 or less, it was defined as being no problem.

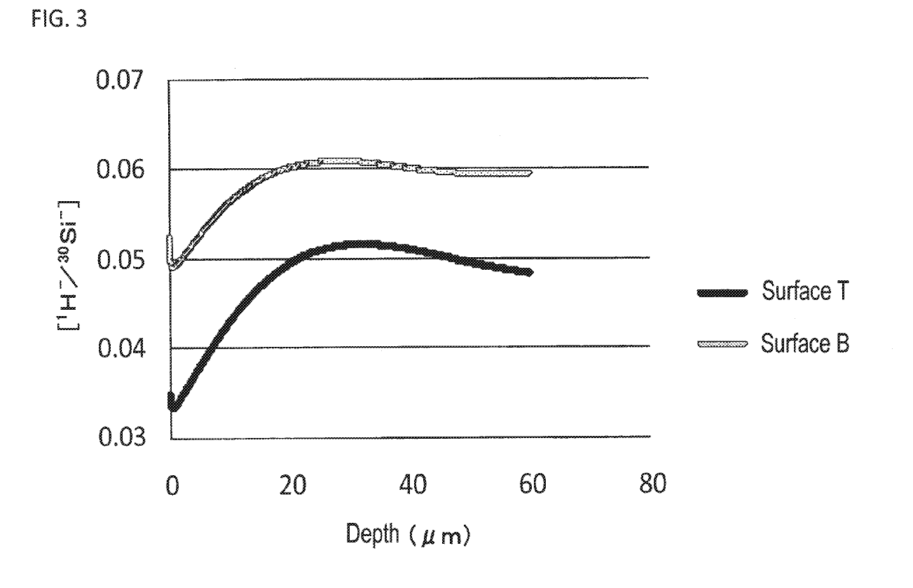

The results obtained are shown in FIGS. 3 to 5 and Table 1.

FIG. 3 is prepared based on a profile (profile corresponding to glass material B in FIG. 5) of hydrogen concentration by secondary ion mass spectrometry of a float glass of Comparative Example 1 (glass material B).

DOL in the top surface of the glass material B is 45.5 μm, and it is considered that K ion entering a glass by ion exchange during chemically strengthening receives the influence of hydrogen concentration up to a depth of 45.5 μm.

Therefore, because it is necessary to consider the whole hydrogen concentration up to 45.5 μm from a surface layer, an average value of hydrogen concentration up to 45.5 μm from the surface layer was considered for the sake of convenience. With regard to the substrate etched before chemical strengthening, it is necessary to consider an average value of hydrogen concentration up to a depth of 45.5 μm from the surface layer.

For example, with regard to the substrate etched to a removal 10 μm, it is necessary to consider an average value of hydrogen concentration up to 55.5 μm from a depth of 10 μm in the graph of glass material B in FIG. 5. Hydrogen concentration at a depth of 0 μm in FIG. 3 shows an average value of hydrogen concentration up to 45.5 μm from 0 μm of glass material B in FIG. 5, and hydrogen concentration at a depth of 10 μm in FIG. 3 shows an average value of hydrogen concentration up to 55.5 μm from 10 μm of glass material B in FIG. 5. Thus, FIG. 3 is a graph obtained by plotting each point.

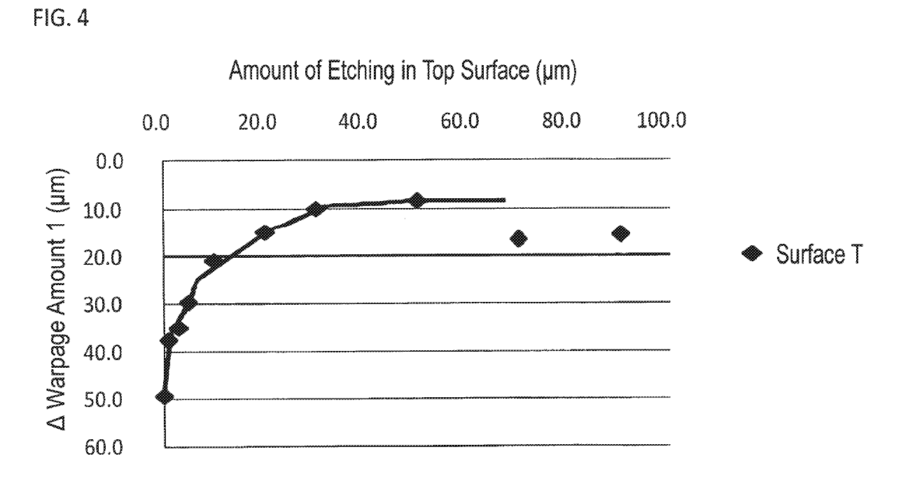

FIG. 4 shows results of measuring the difference in amount of warpage before and after chemical strengthening (Δ warpage amount) when chemically strengthening after etching a top surface of a float glass of Comparative Example 1 (glass material B) to a removal of various depths. For the sake of easy comparison to FIG. 3, the vertical axis (Δ warpage amount) was reversed.

FIG. 3 is prepared based on a profile (glass material B in FIG. 5) of hydrogen concentration by secondary ion mass spectrometry of a float glass of Comparative Example 1 (glass material B).

As shown in FIG. 4, when the amount of etching on the top surface of the float glass was increased, the Δ warpage amount was decreased. Furthermore, the tendency that the Δ warpage amount is decreased with the increase of the amount of etching is very similar to the hydrogen concentration profile shown in FIG. 3. Therefore, it was considered that hydrogen concentration dominates the Δ warpage amount, and the hydrogen concentration and the Δ warpage amount have a correlation.

[¹H⁻/³⁰Si⁻] profiles by secondary ion mass spectrometry of float glass used in Examples and Comparative Examples are shown in FIGS. 5(a) to 5(d). The profile can be identified with hydrogen concentration profile.

As shown in FIG. 5, in the float glass of Examples 1 and 2, regarding [¹H⁻/³⁰Si⁻] obtained by secondary ion mass spectrometry, the difference between a top surface and bottom surface was small as compared with Comparative Examples 1 to 3. Furthermore, as shown in Table 1, the float glass of Examples 1 and 2 have small warpage after chemical strengthening as compared with Comparative Examples 1 to 3. Therefore, it was found that warpage after chemical strengthening can be reduced by decreasing the difference in hydrogen concentration between the top surface and the bottom surface in the float glass.

Furthermore, as shown in Table 1, with regard to the float glass of Examples 1 and 2, regarding the normalized intensity at a depth of 5 to 10 μm that is a value obtained by, in [¹H⁻/³⁰Si⁻] profile obtained by secondary ion mass spectrometry, dividing [¹H⁻/³⁰Si⁻] at a depth of 5 to 10 μm by [¹H⁻/³⁰Si⁻] at a depth of 50 to 55 μm, the difference between that in the top surface and that in the bottom surface was 0.35 or less, and a value (converted into a sheet thickness of 0.7 mm) obtained by dividing the Δ warpage amount by (CS×DOL) was as small as 0.0004. Thus, the warpage after chemical strengthening was small.

On the other hand, regarding the normalized intensity, the float glass of Comparative Examples 1 to 3 in which the difference between the top surface and the bottom surface exceeds 0.35 had large warpage after chemical strengthening as compared with Examples 1 and 2.

It was found form the results that, regarding the normalized intensity at a depth of 5 to 10 μm that is a value obtained by, in [¹H⁻/³⁰Si⁻] profile obtained by secondary ion mass spectrometry, dividing [¹H⁻/³⁰Si⁻] at a depth of 5 to 10 μm by [¹H⁻/³⁰Si⁻] at a depth of 50 to 55 μm, when an absolute value of the difference between the top surface and the bottom surface of a float glass is 0.35 or less, the warpage after chemical strengthening can be reduced.

Furthermore, the float glass of Examples 1 and 2 in which an absolute value of the (t1−t2) during float molding was 80° C. or lower had small warpage after chemical strengthening as compared with Comparative Examples 1 to 3 in which the value exceeds 80° C., and it was therefore found to be preferred that the absolute value of the (t1−t2) is 80° C. or lower.

### Example 2

### (1) Production of Float Glass

A glass sheet of glass material B having the following composition was produced by a float process so as to have a sheet thickness shown in Table 2, and cut into a size of 100×100 mm to prepare float sheet glass of Examples 3 and 4 and Comparative Example 4.

### (Glass Material B)

A glass containing, in mol %, 64.3% of SiO₂, 8% of Al₂O₃, 12.5% of Na₂O, 4% of K₂O, 10.5% of MgO, 0.1% of CaO, 0.1% of SrO, 0.1% of BaO and 0.5% of ZrO₂.

Using a value (t3) obtained by measuring a temperature of a glass blank in a canal with a thermocouple and a value (t4) obtained by measuring a temperature of a glass ribbon in 3 Bay, t1 was calculated using the following calculation formula.

t1=t3−(t3−t4)÷3

Regarding a temperature (t2) of a molten metal bath, an average value of values obtained by measuring a left side and a right side of 1 Bay with a thermocouple was used.

Comparative Example 4 and Example 3 are glass employed from the same glass sheet, but the employed region differs. Comparative Example 4 is the case of a glass of a central part in a sheet width direction, and Example 3 is the case of a glass of an edge part. Radiation thermometer measures only a central region in a width direction of a glass sheet. Therefore, there are no data of |t1−t2| in Example 2, but it is considered as follows.

Glass ribbon temperature at an edge part is lower than that at a central part. On the other hand, tin has high thermal conductivity, and therefore, a temperature is relatively uniform between a central part and an edge part. As a result, it is considered that |t1−t2| at an edge part is smaller than |t1−t2| at a central part.

### (2) Measurement of β-OH in Surface Layer

Measuring surface of a float glass was polished to a removal of 5 μm and then subjected to IR measurement, and absorbance of Si—OH peak was calculated by subtracting an absorbance based on 3,955 cm⁻¹ from absorbance of Si—OH peak top. Thereafter the measuring surface was further polished to a removal of 25 μm, and absorbance of Si—OH peak was similarly measured.

### IR Method

Apparatus: Nicolet 6700, manufactured by Thermo Fisher Scientific.

Detector: Electron cooling DTGS

Integration: 64 times

Frequency resolution: 4 cm⁻¹

β-OH of the target region (depth: 5 to 30 μm) was calculated from the difference in absorbance of Si—OH peaks before and after polishing and a removal thickness by polishing by the following calculation formula.

(β-OH in surface layer)=[(Si—OH absorbance after removal of 5 μm by polishing)−(Si—OH absorbance after removal of 30 μm by polishing)]/thickness removed by polishing

### (3) Measurement of Amount of Warpage

After measuring the amount of warpage with a three-dimensional shape measuring instrument, manufactured by Mitaka Kohki Co., Ltd. (NH-3MA), each float glass was chemically strengthened by dipping in KNO₃ molten salt at 435° C. for 4 hours, and the amount of warpage after chemically strengthening was similarly measured. A value obtained by subtracting the amount of warpage before chemical strengthening from the amount of warpage after chemical strengthening was defined as Δ warpage amount. The Δ warpage amount in a float glass of 10 cm square was defined as Δ warpage amount 2.

The Δ warpage amount 2 is inversely proportional to the square of a sheet thickness. Therefore, to compare the amount of warpage of substrates having difference sheet thickness, calculation converted into a sheet thickness of 0.7 mm was conducted.

(Δ warpage amount 2 in sheet thickness conversion)=(Δ warpage amount 2)×0.7²÷(sheet thickness)²

The Δ warpage amount 2 has nearly a proportional relationship to the degree of chemical strengthening (CS×DOL). Therefore, to eliminate the influence of the difference in the degree of chemical strengthening (CS×DOL), a value by dividing Δ warpage amount by (CS×DOL) was calculated. When (Δ warpage amount 2)/(CS×DOL) is 0.005 or less, it was defined as being no problem.

The results obtained are shown in Table 2 and FIG. 7. Furthermore, the results obtained by measuring β-OH in a surface layer of the float glass of Examples 1 and 2 and the float glass of Comparative Examples 1 to 3, that were produced in [Example 1], in the same manner as in [Example 2] are shown in Table 1.

TABLE 1

| | | | | | Comparative | Comparative | Comparative |
|---|---|---|---|---|---|---|---|
| | | | Example 1 | Example 2 | Example 1 | Example 2 | Example 3 |
| Glass material | | | A | E | B | C | D |
| Sheet thickness (mm) | | | 0.8 | 0.8 | 0.7 | 0.7 | 1.1 |
| \|t1 − t2\| (° C.) | | | 53 | 7 | 103 | 117 | 113 |
| Surface T | [¹H⁻/³⁰Si⁻] (5 to 10 μm) | | 0.015 | 0.016 | 0.026 | 0.016 | 0.026 |
| | [¹H⁻/³⁰Si⁻] (50 to 55 μm) | | 0.053 | 0.049 | 0.072 | 0.05 | 0.079 |
| | Normalized intensity (5 to 10 μm) | | 0.292 | 0.32 | 0.363 | 0.314 | 0.334 |
| | Normalized intensity (50 to 55 μm) | | 1 | 1 | 1 | 1 | 1 |
| Surface B | [¹H⁻/³⁰Si⁻] (5 to 10 μm) | | 0.032 | 0.027 | 0.06 | 0.48 | 0.06 |
| | [¹H⁻/³⁰Si⁻] (50 to 55 μm) | | 0.06 | 0.052 | 0.077 | 0.058 | 0.085 |
| | Normalized intensity (5 to 10 μm) | | 0.541 | 0.51 | 0.784 | 0.824 | 0.71 |
| | Normalized intensity (50 to 55 μm) | | 1 | 1 | 1 | 1 | 1 |
| Normalized intensity difference (5 to 10 μm) (surface B − | | | 0.249 | 0.19 | 0.421 | 0.51 | 0.376 |
| surface T) | | | | | | | |
| β-OH in | Surface T | n = 1 | — | 0.178 | 0.175 | — | — |
| surface layer | | n = 2 | — | 0.176 | — | — | — |
| (5 to 30 μm) | | n = 3 | — | — | — | — | — |
| | | Average | — | 0.177 | 0.175 | — | — |
| | Surface B | n = 1 | — | 0.201 | 0.227 | — | — |
| | | n = 2 | — | 0.196 | — | — | — |
| | | n = 3 | — | — | — | — | — |
| | | Average | — | 0.1985 | 0.227 | — | — |

| | | | | | | |
|---|---|---|---|---|---|---|
| | Difference (surface B − surface T) | — | 0.022 | 0.052 | — | — |
| Chemical | Temperature (° C.) | 435 | 435 | 435 | 435 | 465 |
| strengthening | Time (hr) | 4 | 4 | 4 | 4 | 2 |
| condition | | | | | | |

| | | | | | |
|---|---|---|---|---|---|
| CS (MPa) | 665 | 721 | 783 | 622 | 861 |
| DOL (μm) | 40 | 26 | 44 | 10 | 37 |
| CS × DOL (MPa × μm) | 26394 | 18746 | 34784 | 6039 | 31443 |
| Δ warpage amount 1 (μm) | 8 | 0.5 | 49 | 17 | 25 |
| Δ warpage amount 1 (μm)/CS × DOL (MPa × μm) | 0.0003 | 0.00003 | 0.0014 | 0.0028 | 0.0008 |
| Δ warpage amount 1′ (μm)* | 10 | 0.65 | 49 | 17 | 61 |
| Δ warpage amount 1′ (μm)/CS × DOL (MPa × μm)* | 0.0004 | 0.00003 | 0.0014 | 0.0028 | 0.0008 |
| Δ warpage amount 1″ (μm)** | 40 | 2.6 | 196 | 68 | 244 |
| Δ warpage amount 1″ (μM)/CS × DOL (MPa × μm)** | 0.0015 | 0.0001 | 0.0056 | 0.0113 | 0.0078 |

*Value converted into sheet thickness of 0.7 mm
**Value converted into sheet thickness of 0.7 mm and the square of 100 mm

TABLE 2

| | | | | Comparative |
|---|---|---|---|---|
| | | Example 3 | Example 4 | Example 4 |
| Glass material | | B | B | B |
| Sheet thickness (mm) | | 0.8 | 0.7 | 0.8 |
| Line speed (case where | | 1 | 1.2 | 1 |
| line speed of Comparative | | | | |
| Example 4 is 1) | | | | |
| \|t1 − t2\| (° C.) | | <77 | 77 | 92 |
| CS (MPa) | | 708 | 662 | 70 |
| DOL (μm) | | 48 | 51 | 48 |
| CS × DOL (MPa × μm) | | 33984 | 33762 | 33984 |
| Δ warpage amount 2 (μm) | | 115 | 80 | 143 |
| Δ warpage amount 2 (μm)* | | 150 | 80 | 187 |
| Δ warpage amount 2 (μm)/ | | 0.0044 | 0.0024 | 0.0055 |
| CS × DOL (MPa × μm)* | | | | |
| β-OH in | Ratio (surface | 1.19 | 1.12 | 1.29 |
| surface layer | B/surface T) | | | |
| (5 to 30 μm) | | | | |

*Value converted into sheet thickness of 0.7 mm

As shown in FIG. 7, it was found that when a ratio of the β-OH in a surface layer in the bottom surface to that in the top surface β-OH in surface layer in top surface/β-OH in surface layer in bottom surface) in the float glass is 1.27 or less, the warpage after chemical strengthening can be reduced.

As shown in Table 2, it was found that from the fact that the float glass of Examples 3 and 4 in which the absolute value of (t1−t2) during float molding is 80° C. or less show small warpage after chemical strengthening as compared with Comparative Example 4 in which the value exceeds 80° C., it is preferred that the absolute value of (t1−t2) is 80° C. or less.

Furthermore, it was found from the results of Examples 3 and 4 that when the residence time of a glass in high temperature region is further shortened, dehydration from a top surface is suppressed, and as a result, the amount of warpage can be reduced by reducing the difference in β-OH in a surface layer on a glass surface between the top surface and the bottom surface.

### Reference Example 1

To compare the case in which average H/Si intensity of a float glass was measured under the same analysis conditions (analysis condition A) as in Example 1 with the case in which the average H/Si intensity was measured under analysis conditions in which luster size and ESA input lens of a detector in the analysis condition A were changed (analysis condition B), the following test was conducted.

### (1) Production of Float Glass

A glass having nearly a composition of, in mol %, SiO₂: 66%, Al₂O₃: 5%, Na₂O: 5%, K₂O: 5%, MgO: 3%, CaO: 6%, SrO: 5%, BaO: 4% and ZrO₂: 2% was produced by a float process such that a sheet thickness was 1.8 mm, and cut into a size of 10 mm×10 mm to prepare a float sheet glass. “Unpolished product” and various “polished products” obtained by polishing unpolished products to a removal of 10, 21, 32 and 49 μm with cerium oxide were prepared.

### (2A) Measurement of Average H/Si Intensity

Average H/Si intensity of the float glass obtained was measured by secondary ion mass spectrometry under the following (Analysis Condition A) or (Analysis condition B).

### (Analysis Condition A)

Measuring apparatus: ADEPT 1010, manufactured by Ulvac-Phi, Inc.

Primary ion species: Cs⁺

Primary accelerated voltage: 5.0 kV

Primary ion current: 1 μA

Primary ion incidence angle (angle from vertical direction of sample surface): 60°

Luster size: 200×200 μm²

Detection region: 40×40 μm²

Secondary ion polarity: Minus

Use of electron gun for neutralization: Yes

Field aperture of detector: 1

ESA input lens of detector: 550

The sputtering rate was 14 nm/sec.

### (Analysis Condition B)

Measuring apparatus: ADEPT 1010, manufactured by Ulvac-Phi, Inc.

Primary ion species: Cs⁺

Primary accelerated voltage: 5.0 kV

Primary ion current: 1 μA

Primary ion incidence angle (angle from vertical direction of sample surface): 60°

Luster size: 400×400 μm²

Detection region: 40×40 μm²

Secondary ion polarity: Minus

Use of electron gun for neutralization: Yes

Field Aperture of detector: 1

ESA input lens of detector: 0

The sputtering rate was 3 nm/sec.

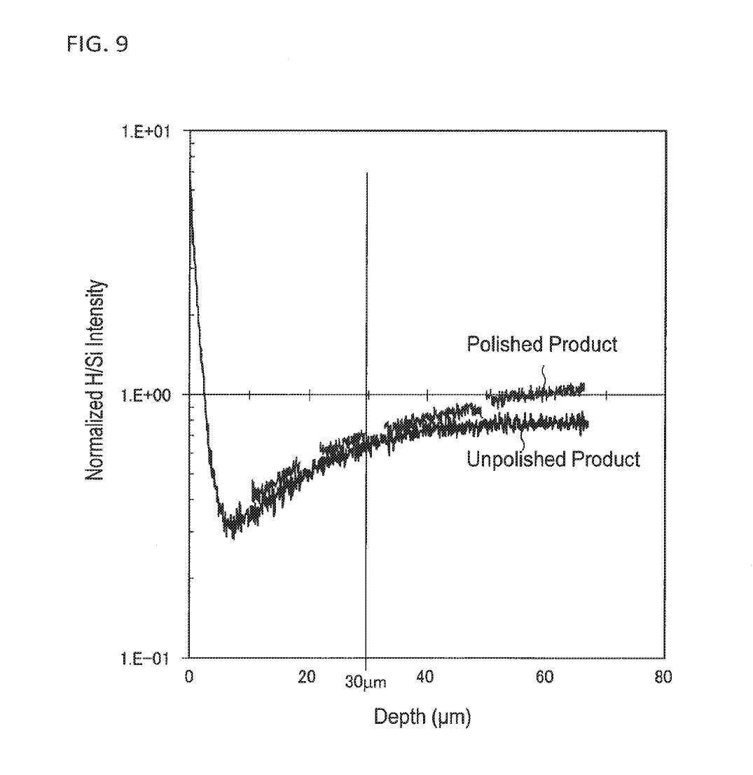

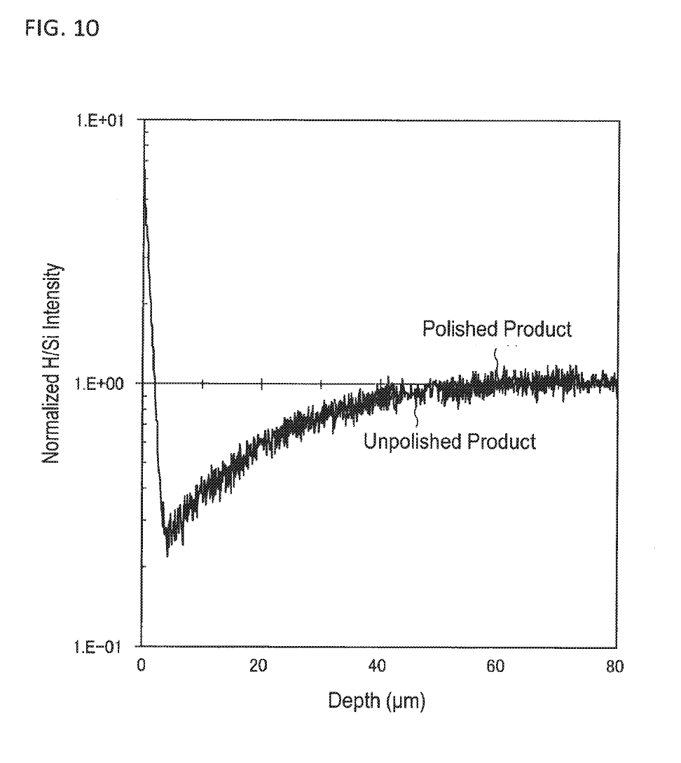

Regarding the unpolished product, 10 μm polished product, 21 μm polished product, 32 μm polished product and 49 μm polished product, H/Si intensity profiles obtained using the analysis condition A are shown in FIG. 9, and H/Si intensity profiles obtained using the analysis condition B are shown in FIG. 10. The H/Si intensity profiles of the polished products are obtained by connecting the H/Si intensity profile of each polished product. The vertical axis in FIGS. 9 and 10 is normalized H/Si intensity when average H/Si intensity at a depth of 55 to 60 μm (depth in the case where the surface before polishing is 0 μm) of the 49 μm polished product is 1.

As shown in FIG. 9, in the measurement under the analysis condition A, deviation occurred in the normalized H/Si intensity between the polished product and the unpolished product. On the other hand, as shown in FIG. 10, in the measurement under the analysis condition B, the normalized H/Si intensity was completely identical.

It was found from the comparison between FIG. 9 and FIG. 10 that, as compared with the measurement under the analytical condition A, in the measurement of average H/Si intensity under the analysis condition B, detection of crater edge component is suppressed and reliability of a bulk value can be improved, and additionally the knock-on effect can be suppressed and precipitous property of profile can be improved.

### Example 3

### (1) Production of Float Sheet Glass

Similar to Example 1, a flat glass sheet was produced by a float process so as to have a sheet thickness of 1.8 mm, followed by cutting into a size of 10×10 mm².

### (2) Secondary Ion Mass Spectrometry

Hydrogen concentration of each float glass of Examples 1 and 2 and Comparative Examples 1 to 3 was analyzed up to a depth of 10 μm or more by secondary ion mass spectrometry.

Analysis conditions of secondary ion mass spectrometry were as follows.

Measuring apparatus: ADEPT 1010, manufactured by Ulvac-Phi, Inc.

Primary ion species: Cs⁺

Primary accelerated voltage: 5.0 kV

Primary ion current: 1 μA

Primary ion incidence angle (angle from vertical direction of sample surface): 60°

Luster size: 400×400 μm²

Detection region: 40×40 μm²

Secondary ion polarity: Minus

Use of electron gun for neutralization: Yes

Field Aperture of detector: 1

ESA input lens of detector: 0

The sputtering rate was 3 nm/sec.

### (3) Measurement of Amount of Warpage

The float glass obtained was cut into a size of 100×100 mm. After measuring the undulation of a substrate having opposing corners of 120 mm with SURFCOM 1400D (manufactured by Tokyo Seimitsu Co., Ltd.) and after correcting a base line, the maximum value and minimum value of the amount of warpage were measured with a three-dimensional shape measuring instrument (NH-3MA) manufactured by Mitaka Kohki Co., Ltd.), and the average value thereof was defined as the amount of warpage.

After measuring the amount of warpage of a float glass before chemical strengthening, each float glass was chemically strengthened by dipping in potassium nitrate molten salt heated to 435° C. for 4 hours, and the amount of warpage after chemical strengthening was similarly measured. A value obtained by subtracting the amount of warpage before chemical strengthening from the amount of warpage after chemical strengthening was defined as Δ warpage amount. The Δ amount of warpage in a float glass of 10 cm square was defined as Δ warpage amount 2.

From the fact that the Δ warpage amount 2 is inversely proportional to the square of a sheet thickness, to compare the amount of warpage of substrates having different sheet thickness, the calculation for converting into a sheet thickness of 0.7 mm was conducted as follows.

(Δ warpage amount 2 converted into sheet thickness)=(Δ warpage amount 2)×0.7²÷(sheet thickness)²

The Δ warpage amount 2 has nearly a proportional relationship to the degree of chemical strengthening (CS×DOL). Therefore, to eliminate the influence of the difference in the degree of chemical strengthening (CS×DOL), a value by dividing the Δ warpage amount by (CS×DOL) was calculated. When (Δ warpage amount 2)/(CS×DOL) is 0.005 or less, it was defined as being no problem.

The results obtained are shown in Table 3.

TABLE 3

| | | | | | Comparative | Comparative | Comparative |
|---|---|---|---|---|---|---|---|
| | | | Example 5 | Example 6 | Example 5 | Example 6 | Example 7 |
| Glass material | | | B | E | B | B | B |
| Sheet thickness (mm) | | | 0.7 | 0.8 | 0.8 | 1.1 | 1.1 |
| \|t1 − t2\| (° C.) | | | 77 | 7 | 92 | 113 | 113 |
| CS (MPa) | | | 661.5 | 740.3 | 678.5 | 699.5 | 699.5 |
| DOL (μm) | | | 50.5 | 30.3 | 49 | 44.726 | 44.726 |
| CS × DOL (MPa × μm) | | | 33406 | 22431 | 33247 | 31286 | 31286 |
| Δ warpage amount 2 (μm) | | | 99 | 71 | 148 | 79 | 79 |
| Δ warpage amount 2 (μm)* | | | 99 | 93 | 193 | 196 | 196 |
| Δ warpage amount 2 (μm)/CS × DOL | | | 0.0030 | 0.0041 | 0.0058 | 0.0063 | 0.0063 |
| (MPa × μm)* | | | | | | | |
| Substrate analyzed | | | Before | Before | Before | Before | After |
| | | | strengthening | strengthening | strengthening | strengthening | strengthening |
| Average H/Si | Surface T | n = 1 | 0.015 | 0.007 | 0.012 | 0.012 | 0.012 |
| intensity (5 to | | n = 2 | — | — | 0.011 | — | — |
| 10 μm) | | n = 3 | — | — | 0.012 | — | — |
| | | Average | 0.015 | 0.007 | 0.011 | 0.012 | 0.012 |
| | Surface B | n = 1 | 0.021 | 0.011 | 0.02 | 0.022 | 0.022 |
| | | n = 2 | — | — | 0.02 | — | — |
| | | n = 3 | — | — | 0.02 | — | — |
| | | Average | 0.021 | 0.011 | 0.020 | 0.022 | 0.022 |

| | | | | | |
|---|---|---|---|---|---|
| Ratio (surface | 1.37 | 1.53 | 1.71 | 1.81 | 1.83 |
| B/surface T) | | | | | |

*Value converted into sheet thickness of 0.7 mm

As shown in Table 3, it was found that when the ratio of the average H/Si intensity at a depth of 5 to 10 μm in H/Si intensity profile obtained by secondary ion mass spectrometry in the bottom surface to that in the top surface of is 1.65 or less, the warpage after chemical strengthening can be reduced.

While the invention has been described in detail and with reference to specific embodiments thereof, it will be apparent to one skilled in the art that various changes and modifications can be made therein without departing from the spirit and scope thereof. This application is based on Japanese Patent Application No. 2011-147494 filed on Jul. 1, 2011 and Japanese Patent Application No. 2011-268931 filed on Dec. 8, 2011, the entire subject matters of which are incorporated herein by reference.

### DESCRIPTION OF REFERENCE NUMERALS AND SIGNS

1 Molten glass
5 Molten metal bath
10 Display device
15 Chassis
20 Display panel
30 Cover Glass

1-9: (canceled)

10: A float glass for chemical strengthening, having a bottom surface to contact a molten metal during molding and a top surface facing the bottom surface and having a thickness of 1.5 mm or less, wherein a hydrogen concentration in the top surface is lower than the hydrogen concentration in the bottom surface, and a ratio of an average H/Si intensity at a depth of 5 to 10 μm in the bottom surface to the average H/Si intensity at a depth of 5 to 10 μm in the top surface is 1.65 or less.

11: The float glass for chemical strengthening according to claim 10, wherein the average H/Si intensity is measured under the following analysis condition:
(Analysis conditions)
Measuring apparatus: Secondary ion mass spectrometer ADEPT 1010 having quadrupole mass analyzer;
Primary ion species: Cs⁺;
Primary accelerated voltage: 5.0 kV;
Primary ion current: 1 μA;
Primary ion incidence angle (angle from vertical direction of sample surface): 60°;
Luster size: 400×400 μm²;
Detection region: 40×40 μm²;
Secondary ion polarity: Minus;
Use of electron gun for neutralization: Yes;
Field Aperture of detector: 1; and
ESA Input Lens of detector: 0.

12: The float glass for chemical strengthening according to claim 10, wherein the ratio of an average H/Si intensity at a depth of 5 to 10 μm in the bottom surface to the average H/Si intensity at a depth of 5 to 10 μm in the top surface is 1.60 or less.

13: The float glass for chemical strengthening according to claim 11, wherein the ratio of an average H/Si intensity at a depth of 5 to 10 μm in the bottom surface to the average H/Si intensity at a depth of 5 to 10 μm in the top surface is 1.60 or less.

14: The float glass for chemical strengthening according to claim 10, wherein the ratio of an average H/Si intensity at a depth of 5 to 10 μm in the bottom surface to the average H/Si intensity at a depth of 5 to 10 μm in the top surface is 1.55 or less.

15: The float glass for chemical strengthening according to claim 11, wherein the ratio of an average H/Si intensity at a depth of 5 to 10 μm in the bottom surface to the average H/Si intensity at a depth of 5 to 10 μm in the top surface is 1.55 or less.

16: The float glass for chemical strengthening according to claim 10, wherein the ratio of an average H/Si intensity at a depth of 5 to 10 μm in the bottom surface to the average H/Si intensity at a depth of 5 to 10 μm in the top surface is 1.53 or less.

17: The float glass for chemical strengthening according to claim 11, wherein the ratio of an average H/Si intensity at a depth of 5 to 10 μm in the bottom surface to the average H/Si intensity at a depth of 5 to 10 μm in the top surface is 1.53 or less.

18: The float glass for chemical strengthening according to claim 10, wherein the ratio of an average H/Si intensity at a depth of 5 to 10 μm in the bottom surface to the average H/Si intensity at a depth of 5 to 10 μm in the top surface is 1.37 or less.

19: The float glass for chemical strengthening according to claim 11, wherein the ratio of an average H/Si intensity at a depth of 5 to 10 μm in the bottom surface to the average H/Si intensity at a depth of 5 to 10 μm in the top surface is 1.37 or less.

20: The float glass for chemical strengthening according to claim 10, comprising in terms of mol %, 50 to 80% of SiO₂, 2 to 25% of Al₂O₃, 0 to 10% of Li₂O, 0 to 18% of Na₂O, 0 to 10% of K₂O, 0 to 15% of MgO, 0 to 5% of CaO and 0 to 5% of ZrO₂.

21: The float glass for chemical strengthening according to claim 11, comprising in terms of mol %, 50 to 80% of SiO₂, 2 to 25% of Al₂O₃, 0 to 10% of Li₂O, 0 to 18% of Na₂O, 0 to 10% of K₂O, 0 to 15% of MgO, 0 to 5% of CaO and 0 to 5% of ZrO₂.

22: The float glass for chemical strengthening according to claim 10, comprising in terms of mol %, 50 to 74% of SiO₂, 1 to 10% of Al₂O₃, 6 to 14% of Na₂O, 3 to 11% of K₂O, 2 to 15% of MgO, 0 to 6% of CaO and 0 to 5% of ZrO₂, wherein a total content of SiO₂ and Al₂O₃ is 75% or less, a total content of Na₂O and K₂O is 12 to 25% and a total content of MgO and CaO is 7 to 15%.

23: The float glass for chemical strengthening according to claim 11, comprising in terms of mol %, 50 to 74% of SiO₂, 1 to 10% of Al₂O₃, 6 to 14% of Na₂O, 3 to 11% of K₂O, 2 to 15% of MgO, 0 to 6% of CaO and 0 to 5% of ZrO₂, wherein a total content of SiO₂ and Al₂O₃ is 75% or less, a total content of Na₂O and K₂O is 12 to 25% and a total content of MgO and CaO is 7 to 15%.

24: A method for producing a chemically strengthened float glass, comprising chemically strengthening a float glass having a bottom surface to contact a molten metal during molding and a top surface facing the bottom surface and having a thickness of 1.5 mm or less, wherein, in the float glass, a hydrogen concentration in the top surface is lower than the hydrogen concentration in the bottom surface and a ratio of an average H/Si intensity at a depth of 5 to 10 μm in the bottom surface to the average H/Si intensity at a depth of 5 to 10 μm in the top surface is 1.65 or less.

25: The method for producing a chemically strengthened float glass according to claim 24, wherein a surface compressive stress of the chemically strengthened float glass is 600 MPa or more, and a depth of a surface compressive stress layer of the chemically strengthened float glass is 15 μm or more.
